(19) United States
(12) Patent Application Publication
(10) Pub. No.: US 2009/0273713 A1
(43) Pub. Date: Nov. 5, 2009

(54) DEVICE AND/OR METHOD FOR WARNING ALERT RECEPTION DURING POWER OUTAGE

(75) Inventors: Stuart O. Goldman, Scottsdale, AZ (US); Carlos Solari, Shenandoah, VA (US); Karl F. Rauscher, Emmaus, PA (US)

Correspondence Address: FAY SHARPE/LUCENT, 1228 Euclid Avenue, 5th Floor, The Halle Building, Cleveland, OH, 44115-1843, US

(73) Assignee: Lucent Technologies, Inc., Murray Hill, NJ (US)

(21) Appl. No.: 12/114,365

(22) Filed: May 2, 2008

(51) Int. Cl. H04N 5/50

(52) U.S. Cl. 348/563; 348/E05.097

(57) ABSTRACT

An electrically powered device (10) is provided that is equipped to receive television transmissions. Suitably, the device (10) is operative in one of two states, including a first state in which the device (10) is powered up for normal operation and a second state in which the device (10) is powered down for operation in a standby mode. The device (10) includes: a tuner (14) that is used to select a particular television channel for reception by the device (10); a controller (24) that is operative in the standby mode to set the tuner (14) to a designated channel and monitor the tuner (14) for at least one of an emergency alert, warning or public interest message received on the designated channel, wherein upon detection of an emergency alert, warning or public interest message, the controller (24) switches the device (10) into the first state so as allow the device (10) to output the detected emergency alert, warning or public interest message; and, a power supply (12) arranged to be operatively connected to an electric mains and provide electric power to selected components of the device (10) in accordance the device's operative state, wherein when the device is in the standby mode power from the supply (12) is still provided to the tuner (14) and controller (24) while not being supplied to one or more other electrically powered components of the device (10).

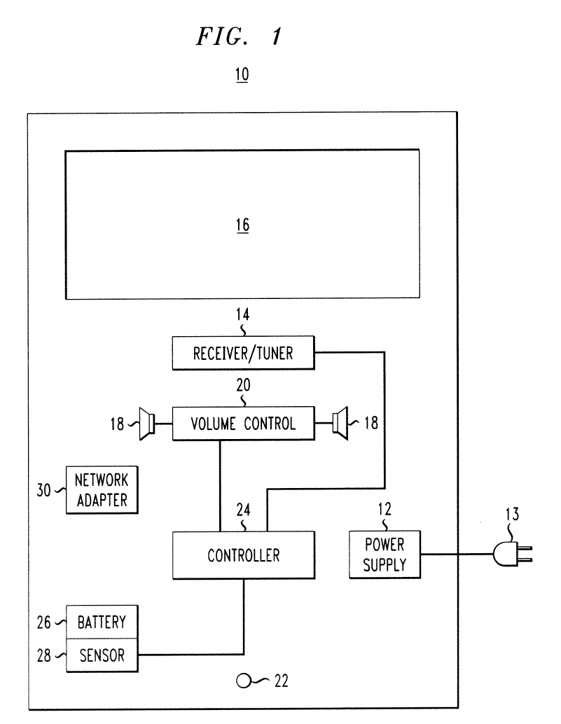

### FIELD

The present inventive subject matter relates to the art of public safety alert and/or warning systems. Particular application is found in conjunction with certain types of receiving devices and/or particular types of alert or warning systems, and the specification makes particular reference thereto. However, it is to be appreciated that aspects of the present inventive subject matter are also amenable to other like applications and/or systems.

### BACKGROUND

Government and/or other agencies are generally committed to developing and/or making available systems and/or mechanisms to warn or alert the populations they serve of emergency conditions and/or other situations of public interest, for example, that concern particular geographic areas. These warnings or alerts or other like messages can be broadcast or otherwise disseminated to inform the population of a wide range of emergencies and/or public concerns such as, e.g., sever or other weather conditions, natural or other disasters, traffic or other transportation conditions, police activity or warnings, national or local defense alerts, medical emergencies, quarantines, disease outbreaks or other public health issues, air or water quality updates, ultraviolet or other radiation levels, extreme environmental conditions or environmental accidents, reports on insect or other infestations or invasive species, etc. In particular, the United States of America has employed the Emergency Broadcast System (EBS) and/or the Emergency Alert System (EAS) to inform the public at large about emergency conditions and/or other situations of public interest. Additionally, the Telecommunication Development Sector of the International Telecommunication Union (ITU-D) is currently developing “Guidelines for Using a Content Standard for Alerts and Notifications in Disasters and Emergency Situations.”

In any event, as is generally known in the art, some radio receivers are equipped to monitor and/or receive alerts, warnings and/or other like messages broadcast by a government or other agency. For example, in the United States of America, the National Weather Service (NWS) broadcasts suitable alerts, warnings and/or other like messages over the National Weather Radio (NWR) network. Properly equipped radio receivers are provisioned to detect such alerts, warnings and/or messages and/or play or otherwise output the same. In some cases, the radios may be equipped to automatically detect and/or play a broadcast alert, warning or message even if the radio is powered “off” or in a standby mode or the audio output of the radio is turned down or off. Similarly, public warnings, alerts and/or other like messages are also broadcast or otherwise disseminated via television transmissions. For example, the EBS and/or EAS provides public warnings, alerts and/or other like messages which can be received by the public on their televisions.

While generally useful for receiving broadcast alerts, warnings or other like messages, dedicated “weather” radios are not widely used by the public. Accordingly, relying on such radios will not fully serve the general interest of informing the public at large about emergency situations. Moreover, radios and televisions are commonly powered by electricity received from an alternating current (AC) outlet or other connection to an electric mains or domestic power. Accordingly, when an electrical power outage is experienced by the mains (as may commonly be the case in many emergency situations), the radios and/or televisions so powered may not be operable to receive a warning or alert or other such broadcast or transmission.

Of course, handheld and/or portable radios in many instances may optionally be battery powered. However, the batteries may be dead due to age or otherwise. Moreover, the public in general relies more and more on their televisions as a primary (and in some instances as a sole) source of information. Accordingly, it is common that an individual may not have a suitable radio for receiving emergency alerts, warnings or other messages during an electrical power outage. Additionally, while batteries may be suitable as a power source for some smaller devices, such as handheld or portable radios, they are not generally employed as power sources in electronic devices, such as today's popular televisions, that demand significantly more power for normal operation. For example, a conventional 32 inch liquid crystal display (LCD) television consumes about 200 watts when powered on. As can be appreciated, this load would drain any reasonably sized battery too quickly to be practical as a normal power source for such a television.

Accordingly, a new and improved device and/or method for receiving emergency alerts, warning and/or other messages of public interest is disclosed that overcomes the above-referenced problems and others.

### SUMMARY

In accordance with one embodiment, an electrically powered device is provided that is equipped to receive television transmissions. Suitably, the device is operative in one of two states, including a first state in which the device is powered up for normal operation and a second state in which the device is powered down for operation in a standby mode. The device includes: a tuner that is used to select a particular television channel for reception by the device; a controller that is operative in the standby mode to set the tuner to a designated channel and monitor the tuner for at least one of an emergency alert, warning or public interest message received on the designated channel, wherein upon detection of an emergency alert, warning or public interest message, the controller switches the device into the first state so as allow the device to output the detected emergency alert, warning or public interest message; and, a power supply arranged to be operatively connected to an electric mains and provide electric power to selected components of the device in accordance the device's operative state, wherein when the device is in the standby mode power from the supply is still provided to the tuner and controller while not being supplied to one or more other electrically powered components of the device.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

The FIGURE is box diagram showing an exemplary emergency alert, warning or other like message receiving device suitable for practicing aspects of the present inventive subject matter.

### DETAILED DESCRIPTION OF PREFERRED EMBODIMENTS

For clarity and simplicity, the present specification shall refer to structural and/or functional elements, entities and/or facilities, relevant standards, protocols and/or services, and other components that are commonly known in the art without further detailed explanation as to their configuration or operation except to the extent they have been modified or altered in accordance with and/or to accommodate the preferred embodiment(s) presented herein.

The FIGURE shows a device 10 for receiving and/or playing emergency alerts, warnings and/or other public interest messages that are broadcast, transmitted or otherwise disseminated by a suitable government or other agency or some intermediary or other suitable proxy acting on behalf thereof. For example, the emergency alerts, warnings and/or other public interest messages are optionally broadcast, transmitted or otherwise disseminated by conventional over-the-air television and/or radio broadcasters, cable television providers, satellite television and/or radio providers, as wells as a range of other telecommunication service providers, including Internet service providers and traditional wired and/or wireless telephone service providers. Optionally, the alerts, warnings and/or other public interest messages are provided using the Common Alerting Protocol (CAP) defined by the ITU-D.

In the illustrated example, the device 10 is a television (TV) equipped to receive the emergency alerts, warnings and/or other public interest messages broadcast or otherwise transmitted by over-the-air television broadcasters, cable and/or satellite television providers or other like television service providers. As shown in the FIGURE, the TV 10 is generally equipped in the usual manner, e.g., including:
a power supply 12 that plugs-in to an AC outlet via a plug 13 or otherwise connects to electric mains or a source of domestic electricity to provide electric power for normal operation of the TV 10;
a receiver and/or tuner 14 that used to select a particular television channel to be received by the TV 10;
a screen or monitor 16 for displaying video output corresponding to a selected input signal which may be: (i) the channel selected on and/or by the receiver/tuner 14, or (ii) an alternate input signal (e.g., such as from a DVD (Digital Video Disc) player or other source);
one or more speakers 18 for playing audio output corresponding to the selected input signal (i.e., from the receiver/tuner 14 or an alternate source);
a volume control 20 that controls the output volume of the speakers 18 and/or selectively mutes that same; and,
a power switch and/or button 22 that is selectively employed to turn the TV 10 “on” or otherwise power up the TV 10 for normal operation and/or turn the TV 10 “off” or otherwise place the TV 10 in a powered down or sleep or standby mode.

In the exemplary embodiment, the TV 10 is also equipped with a controller 24 that regulates the operation of the TV 10 and/or the various components therein. Suitably, via the controller 24, the TV 10 has the ability to monitor for and/or automatically detect emergency alerts, warnings and/or other like public interest messages even when the TV 10 is powered off or down or is in the sleep or standby mode, e.g., in accordance with operation of the power switch or button 22.

More specifically, when the TV 10 is powered off or down or is in the sleep or standby mode, while the other TV components are generally not receiving power, the controller 24 and/or the receiver/tuner 14 continue to be powered, e.g., by the power supply 12 or alternately by a backup battery 26 (as will be described later herein). Suitably, when the TV 10 is powered off or down or is in the sleep or standby mode, the controller 24 sets the receiver/tuner 14 to a designated channel and monitors the same to detect receipt of an emergency alert, warning and/or other like public interest message. By first setting the receiver/tuner 14 to a designated channel and then monitoring the same, the controller 24 is able to avoid missing a potential alert, warning or other like message in the case where the TV 10 may have been last set-up to output audio and/or video from an alternate input source, e.g., such as a DVD player. Suitably, the designated channel to which the receiver/tuner 14 is first set by the controller 24 is either a pre-established default channel, e.g., selected by a user, or alternately, it may be the television channel to which the receiver/tuner 14 was most recently tuned.

Suitably, an emergency alert, warning or other like public interest massage is detected by the controller 24 recognizing an established header signal or other like indicator that is broadcast or otherwise transmitted ahead of or just before the alert, warning or other like message. Accordingly, when the header signal or other like indicator is received by the receiver/tuner 14 and recognized by the controller 24 monitoring the same, then the TV 10 is powered up or otherwise turned on automatically by the controller 24 to play or otherwise output the alert, warning and/or message that follows, e.g., via the screen 16 and/or the speakers 18. Suitably, if the volume control 22 is set to mute the speakers 18 (e.g., because the user prefers to employ the external speakers of a home theater system or for whatever other reason), optionally, the controller 24 overrides or bypasses the mute setting on the volume control 22 or otherwise instructs the volume control 22 to un-mutes the speakers 18 when an emergency alert, warning and/or other like public interest message has been detected and/or is going to be played or otherwise output by the TV 10.

Optionally, as illustrated in the FIGURE, the TV 10 also includes a backup battery 26. Suitably, the battery 26 is rechargeable, and when available, power from supply 12 recharges and/or maintains the charge in the battery 26 at a desired or prescribed level. In practice, the backup battery 26 provides power to the TV 10 and/or selected components therein when the electric mains or domestic power to which the power supply 12 is connect experiences an outage or when the power supply 12 otherwise fails to deliver power to the TV 10 and/or selected components therein.

More specifically, when electric power is not available from the supply 12, the other TV components generally do not receive power—however, the battery 26 continues to power the controller 24 and the receiver/tuner 14 so as to monitor for and/or detect emergency alerts, warnings and/or other like public interest messages as described above. Provided an alert, warning or other like message is detected, the battery 26 then also suitably provides power to the speakers 18 so as allow the TV 10 under the direction of the controller 24 to play or otherwise output at least the audio portion thereof. Suitably, however, power from the battery 26 is not provided to the screen 16. By not powering the screen 16, the life of the battery 26 is significantly extended. Optionally, the battery 26 is sized, dimensioned and/or otherwise provisioned to power the controller 24 and/or the receiver/tuner 14 to perform approximately 8 hours of the monitoring function without power from the supply 12 and/or to provide 2 audio playbacks or like outputs of alerts, warnings or other like messages at full volume without power from the supply 12.

Suitably, the TV 10 is also equipped with a battery sensor 28, e.g., such as a continuous passive monitoring circuit or the like, that detects when the battery 26 is low on available charge or electric power. When such a condition is detected (which should be a rare event in light of the rechargeable nature of the battery 26, and accordingly, usually only associated with significant battery aging), the sensor 28 signals or otherwise informs the controller 24 of the weakened battery condition. In response, the controller 24 provides an alert to the user of the battery condition. For example, an optional signal light (not shown) may be illuminated, flashed or otherwise controlled to indicate the battery condition. In another embodiment, a signal indicative of the battery condition may be output via the screen 16 and/or the speakers 18. Suitably, in one option, the controller 24 may preempt the otherwise normal operation of the TV 10 to output a visual and/or audible indication of the battery condition via the screen 16 and/or speakers 18. In another suitable embodiment, normal operation of the TV 10 is not preempted, rather, when the power switch or button 22 or other like control is used in attempt to switch the TV 10 off or otherwise power down the TV 10 or place the TV 10 in a sleep or standby mode, then the controller 24 generates the aforementioned battery condition signal and may optionally request a user input acknowledging the battery condition and/or that it is time to replace the battery 26. Of course, when electric power is available from the supply 12, the components involved in the foregoing battery monitoring and/or signaling of the battery condition can be powered by the supply 12.

In one suitable embodiment, the controller 24 may not only detect and/or recognize the header or other like indicator of an alert, warning or other like message, but may also detect and/or recognize additional control signals and/or indicators within or otherwise accompanying the alert, warning and/or message itself. For example, such control signals and/or indicators may request that and/or instruct the controller 24 to automatically change the receiver/tuner 14 to a selected channel on which more immediate and/or detailed information is being provided with regard to a particular emergency affecting a given geographic region or area. Additionally, the TV 10 may also optionally be equipped with a network adapter 30 or the like or some other suitable connection that permits the TV 10 to operatively communicate (e.g., via a wired or wireless local area network (LAN) or other suitable network or link) with other networked equipment and/or devices. Accordingly, control signals and/or indicators accompanying the received alert, warning or other like message, that are detected and/or recognized by the controller 24 can optionally include requests or instructions that are forwarded by the controller 24 to the other networked equipment and/or devices (e.g., via the network adapter 30) to turn on or off or otherwise regulate the operation of the other networked equipment and/or devices.

For example, a dwelling may have an air circulation system connected to a LAN to which the TV 10 is also operatively connected via the adapter 30. Presuming an environmental accident made the outside air dangerous to breath, an appropriate agency would broadcast or otherwise transmit an emergency alert or warning and include therewith a control signal containing instructions to shut-off air circulation systems and/or close external air intake vents. When the TV 10 received the television broadcast or other transmission including the emergency alert or warning, the controller 24 would recognize the accompanying control signal and forward it or another suitable corresponding signal or message to the air circulation system over the network to which the TV 10 was connected via the adapter 30. The air circulation system may then comply accordingly. Of course, this is merely one example, and many other similar examples for different types of networked equipment and/or devices and/or for different types of control signals and/or emergencies can be readily envisioned.

While the above described example make reference to TV 10, it is to be appreciated that one or more other devices may likewise be employed to implement one or more aspects of the present inventive subject matter, e.g., such as other broadcast or transmission receiving devices. For example, in some instance, a separate cable box or satellite receiver may optionally include the receiver/tuner 14 and/or the controller 24, while an associated TV or monitor to which the cable or satellite receiver is operatively connected includes the screen 16 and/or speakers 18. Suitably, in such cases, both devices would optionally include a power supply such as supply 12, a backup battery such as battery 26 and optional battery sensors such as sensor 28, and communication between the devices would optionally be carried out via an operative communication link therebetween to achieve operation of the respective devices resulting in the same or similar outcomes to those described above.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. An electrically powered device equipped to receive television transmissions, wherein the device is operative in one of two states, including a first state in which the device is powered up for normal operation and a second state in which the device is powered down for operation in a standby mode, said device comprising:
a tuner that is used to select a particular television channel for reception by the device;
a controller that is operative in the standby mode to set the tuner to a designated channel and monitor the tuner for at least one of an emergency alert, warning or public interest message received on the designated channel, wherein upon detection of an emergency alert, warning or public interest message, the controller switches the device into the first state so as allow the device to output the detected emergency alert, warning or public interest message; and,
a power supply arranged to be operatively connected to an electric mains and provide electric power to selected components of the device in accordance the device's operative state, wherein when the device is in the standby mode power from the supply is still provided to the tuner and controller while not being supplied to one or more other electrically powered components of the device.

2. The device of claim 1, wherein the device further includes:
a screen that displays video output corresponding to a selected input signal; and,
a speaker that plays audio output corresponding to the selected input signal;
wherein the screen and the speaker do not receive power from the power supply when the device is in the standby mode but do receive power from the power supply when the device is in the first state.

3. The device of claim 2, wherein the device further includes:
a backup battery arranged to provide electric power to selected components of the device when electric power is not available from the power supply.

4. The device of claim 3, wherein when the device is in standby mode, the battery supplies electric power to the controller and the tuner but not to the speaker and screen.

5. The device of claim 4, wherein when the device is in the first state, the battery supplies electric power to the controller, the tuner and the speaker but not to the screen.

6. The device of claim 5, wherein the battery is rechargeable, and when available, electric power from the power supply recharges the battery to maintain the battery at a prescribed charge level.

7. The device of claim 6, wherein the device further includes:
a battery sensor that monitors a strength of the battery, such that if the strength of the battery falls below a threshold value, then a signal indicative of a condition of the battery is output from the device.

8. The device of claim 2, wherein the device further includes:
a volume control that selectively mutes output from the speaker.

9. The device of claim 8, wherein upon detection of an emergency alert, warning or public interest message, the controller signals the volume control to un-mute output from the speaker.

10. The device of claim 1, wherein the device further includes:
means for operatively connecting the device to a network to which one or more other networked devices are also operatively connected.

11. The device of claim 10, wherein the controller is also operative to detect control signals accompanying a detected emergency alert, warning or public interest message.

12. The device of claim 11, wherein when the controller detects a control signal accompanying a detected emergency alert, warning or public interest message, one of the control signal or a corresponding message is forwarded over the network to one or more of the other networked devices to which the control signal relates.
